(19) United States
(12) Patent Application Publication
(10) Pub. No.: US 2010/0090480 A1
(43) Pub. Date: Apr. 15, 2010

(54) STRIKER ASSEMBLY FOR VEHICLE

(75) Inventor: Sung Don PYUN, Suwon-si (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/464,676

(22) Filed: May 12, 2009

(30) Foreign Application Priority Data
Oct. 14, 2008 (KR) 10-2008-0100703

(51) Int. Cl. E05B 15/02

(52) U.S. Cl. 292/341.15

(57) ABSTRACT

The present invention provides a striker assembly for a vehicle which is locked to or unlocked from a latch assembly of a trunk lid. The striker assembly to be locked to or unlocked from a latch assembly of a trunk lid for a vehicle, may include a housing mounted to a vehicle body, a striker base, one end of which is rotatably coupled to the housing, wherein the striker base includes a striker corresponding to the latch assembly, an actuator mounted to a stationary member, a power transmission unit to convert an actuating force of the actuator into a reciprocating motion of the striker base with respect to the one end of the striker base, and a controller to apply an operating signal to the actuator.

### CROSS-REFERENCE TO RELATED APPLICATION

The present application claims priority to Korean Application No. 10-2008-0100703, filed on Oct. 14, 2008, the entire contents of which is incorporated herein for all purposes by this reference.

### BACKGROUND OF THE INVENTION

1. Field of the Invention

The present invention relates to a striker assembly for a vehicle which converts a striker between two positions to open or close a trunk lid.

2. Description of Related Art

Generally, a trunk lid is opened by manipulating a trunk opening switch disposed adjacent to a driver's seat, or inserting a key into a key box installed in the trunk lid and rotating the key, or manipulating an operating knob provided in the trunk.

As shown in FIG. 5, a latch assembly of a trunk lid according to a conventional technique includes a fork lever 20 which is provided on a base plate 10 and which locks or releases a striker, a pawl lever 30 which locks or releases the fork lever 20, and a spring 40 which is connected between the fork lever 20 and the pawl lever 30. The latch assembly further includes an actuator 50 which provides force for rotating the pawl lever 30, a shift lever 60 which rotates the pawl lever 30 to releases the fork lever 20 that is in the locked state, and an actuating knob 70 which actuates the shift lever 60.

When the actuating knob 70 is pulled in a direction in which the trunk lid is opened, the shift lever 60 is rotated by the operation of the actuating knob 70. Then, the pawl lever 30 which is operated in conjunction with the shift lever 60 is rotated on the base plate 10. At this time, the spring 40 which is connected to the pawl lever 30 is extended. The spring 40 that is extended by the rotation of the pawl lever 30 pulls the fork lever 30 and thus rotates it. Thereby, the striker is released from the fork lever 30.

However, in the conventional technique, because the striker is fastened to a rear portion of the vehicle body, there is a disadvantage in that when the trunk lid is opened, operation between the striker and the latch assembly is not smooth.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a striker assembly for a vehicle in which conversion of the position of a striker for purposes of opening or closing a trunk lid can easily be conducted using a simple circuit structure.

In an aspect of the present invention, the striker assembly to be locked to or unlocked from a latch assembly of a trunk lid for a vehicle, may include a housing mounted to a vehicle body, a striker base, one end of which is rotatably coupled to the housing, wherein the striker base includes a striker corresponding to the latch assembly, an actuator mounted to a stationary member, a power transmission unit to convert an actuating force of the actuator into a reciprocating motion of the striker base with respect to the one end of the striker base, and a controller to apply an operating signal to the actuator wherein the stationary member may be the housing, wherein the actuator may be a drive motor, and wherein the other end of the striker base is eccentrically coupled to the power transmission and configured to swing with respect to the one end of the striker base.

A position limit member may be configured to limit a reciprocating angle of the striker base, wherein the position limit member is shaped of a slot formed through the striker base and a position limit protrusion is provided on the housing, the position limit protrusion slidably coupled to the slot so as to limit the reciprocating motion of the striker base within a predetermined range.

The power transmission unit may include a rotating member that couples a rotation axis of the actuator and the other end of the striker base eccentrically, wherein the power transmission unit further includes a direction conversion member that changes a movement direction of the other end of the striker according to a rotation angle of the rotating member.

The direction conversion member may include a guide slot formed on the other end of the striker base and coupled to a guide protrusion formed on a distal end portion of the rotating member, wherein the guide slot is curved into a ‘V’ shape and has an upper cam portion and a lower cam portion.

The power transmission unit may include a worm gear including a rotating shaft, the worm gear receiving an actuating force from the actuator through the rotating shaft, a spur gear rotatably provided on the housing and engaging with the worm gear, and a guide protrusion provided on the spur gear and being eccentrically coupled to a guide slot formed on the other end of the striker base, wherein the striker base may be configured to reciprocate between a locked position of the trunk lid and an unlocked position thereof when the rotating shaft rotates and wherein the controller has a switch to supply a current having a same polarity such that the actuator is rotated in one direction, and the rotating shaft is rotated in the one direction when an operating signal of the controller is applied to the actuator.

The guide slot may include a cam structure curved into a ‘V’ shape.

A position limit slot may be formed through the striker base to limit the reciprocating motion of the striker base within a predetermined range, and a limit protrusion is provided on the housing and slidably coupled to the position limit slot.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view illustrating an exemplary striker assembly for a vehicle, according to the present invention.

FIG. 2A is a view showing the internal construction of the exemplary striker assembly of FIG. 1.

FIG. 2B is a view showing the operation of the exemplary striker assembly of FIG. 1.

FIG. 3 is a schematic view showing a controller of the exemplary striker assembly according to the present invention.

FIG. 4A is a view showing the operation of the exemplary striker assembly when a trunk lid is opened according to the present invention.

FIG. 4B is an enlarged view of a circled portion “A” of FIG. 4A.

FIG. 5 is a view showing the construction of a striker assembly for a vehicle according to a conventional technique.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

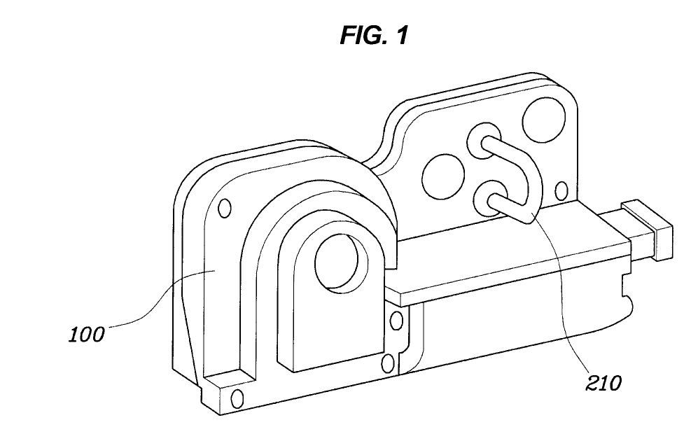

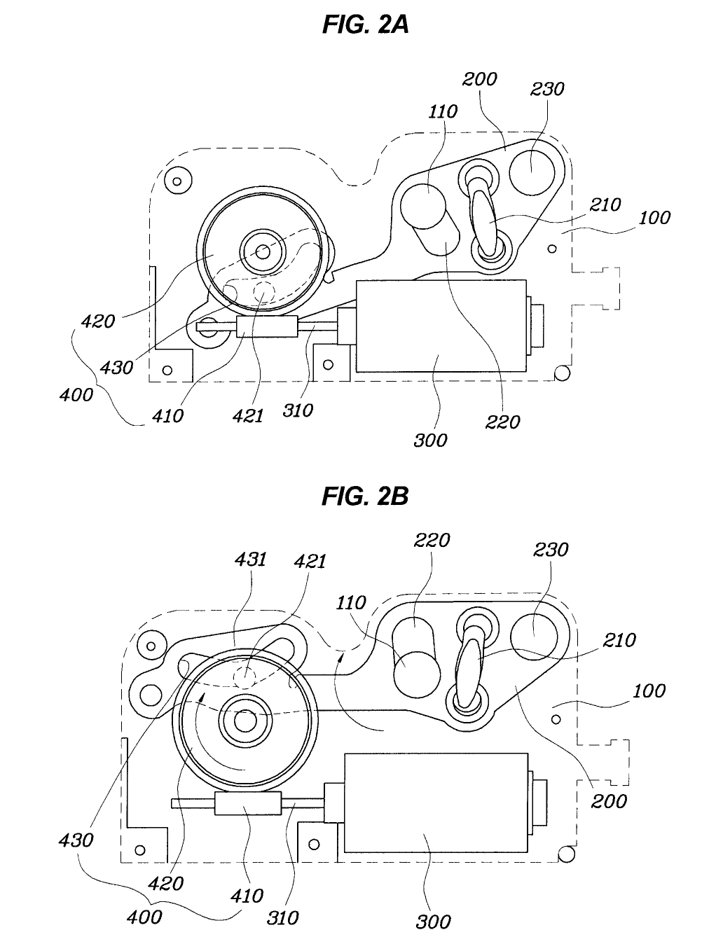

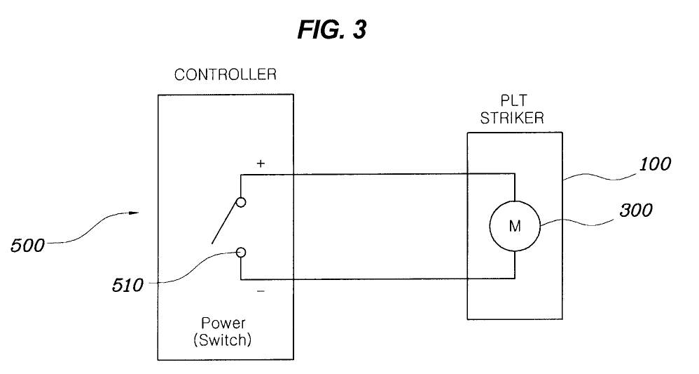

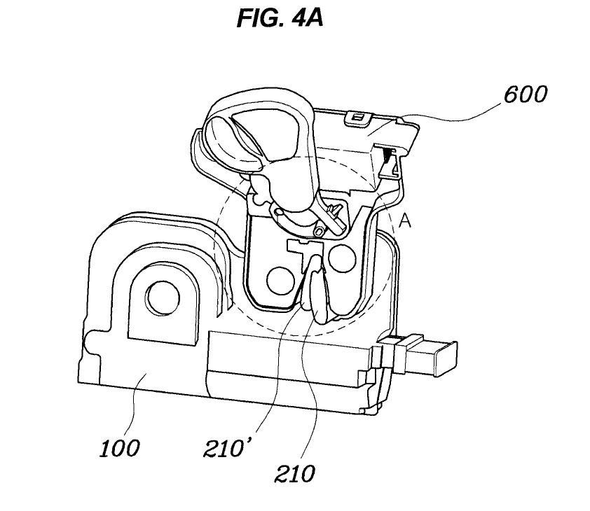

As shown in FIGS. 1 through 3, a striker assembly for a vehicle according to an exemplary embodiment of the present invention is characterized in that one-way rotational motion of a drive motor 300 is converted into reciprocating motion of a striker base 200 under the control of a controller 500 so that a trunk lid can be smoothly opened and closed.

To achieve the above purposes, the striker assembly includes a housing 100, the striker base 200 which is rotatably coupled to the housing 100, and the drive motor 300 which is mounted to the housing 100. The striker assembly further includes a power transmission unit 400 which converts the operating force of the drive motor 300 into reciprocating motion of the striker base 200, and the controller 500 which applies an operating signal to the drive motor 300.

In detail, the housing 100 is mounted to a rear portion of a vehicle body at a position corresponding to that of the latch assembly of the trunk lid. The drive motor 300, the striker base 200, and the power transmission unit 400 are installed on the housing 100. A striker 210 having a ‘U’ shape is provided on the striker base 200. When the trunk lid is opened or closed, the striker 210 is locked to or unlocked from the latch assembly, thus controlling the opening of the trunk lid.

A first end of the striker base 200 is rotatably coupled to the housing 100 by a hinge shaft 230. Thus, a second end of the striker base 200 can swing around the hinge shaft 230 within a predetermined angular range. At this time, the striker 210 also rotates around the hinge shaft 230 by the swinging motion of the striker base 200. In other words, the position of the striker 210 can be varied by the swinging motion of the striker base 200.

Furthermore, a position limit slot 220 is formed through the striker base 200 to define the angular range within which the striker base 200 swings. A limit protrusion 110 which is disposed in the position limit slot 220 is provided on the housing 100. That is, when the striker base 200 swings, the angle at which the striker base 200 swings is limited by the limit protrusion 110 which is disposed in the position limit slot 220, so that the striker base 200 can reciprocate between a locked position of the trunk lid and an unlocked position thereof.

In addition, a guide slot 430 is formed through the second end of the striker base 200 and is used to convert rotational motion of a spur gear 420 into reciprocating motion of the striker base 200. A cam structure 431 which is curved into a ‘V’ shape is formed in the guide slot 430. When the spur gear 420 rotates, the cam structure 431 guides movement of a guide protrusion 421 of the spur gear 420, such that the rotational motion of the spur gear 420 can be smoothly converted into the swinging motion of the striker base 200. The cam structure 431 may include an upper cam and a lower cam that the guide protrusion 421 may contact alternatively according to the rotational angle of the spur gear 420.

Meanwhile, the drive motor 300 which generates operating force for swinging the striker base 200 is mounted to the housing 100. In various embodiments of the present invention, the drive motor 300 has a rotating shaft 310, on which a worm gear 410 is provided. The controller 500, which controls the drive motor 300 such that the rotating shaft 310 rotates in one direction, is electrically connected to the drive motor 300. In other words, when an operating signal is applied to the drive motor 300 from the controller 500, the drive motor 300 rotates the rotating shaft 310 depending on the operating signal and thus provides operating force to the striker base 200.

In other embodiments of the present invention, the drive motor 300 may be connected to the rotation axis of the super gear 429 without worm gear 410 so that the structure of the striker assembly may be further simplified.

The controller 500 has a switch 510 which controls the one-way rotation of the rotating shaft 310. The switch 510 is electrically connected to the drive motor 300 such that current having the same polarity is evenly supplied to the drive motor 300. Therefore, movement of the rotating shaft 310 of the drive motor 300 is determined by an operating signal applied to the drive motor 300 from the controller 500. The rotating force of the rotating shaft 310 swings the striker base 200 via the power transmission unit 400.

The power transmission unit 400 converts the rotational motion of the drive motor 300 into the swinging motion of the striker base 200. For this, the power transmission unit 400 includes the worm gear 410 which is provided on the rotating shaft 310, the spur gear 420 which engages with the worm gear 410 and is rotatably mounted to the housing 100, and the guide slot 430 which is formed through the first end of the striker base 200. The guide protrusion 421 which is disposed in the guide slot 430 protrudes from the spur gear 420. Thus, when the spur gear 420 rotates, the guide slot 430 is guided by the guide protrusion 421 such that the striker base 200 swings.

In other words, the spur gear 420 which engages with the worm gear 410 of the rotating shaft 310 is rotated by rotation of the rotating shaft 310. The guide protrusion 421 of the spur gear 420 is rotated by the rotation of the spur gear 420. At this time, the guide protrusion 421 reciprocates along the guide slot 430 of the striker base 200. Thereby, the striker base 200 can be swung around the hinge shaft 230.

The operation of an exemplary embodiment of the present invention having the above-mentioned construction will be explained below.

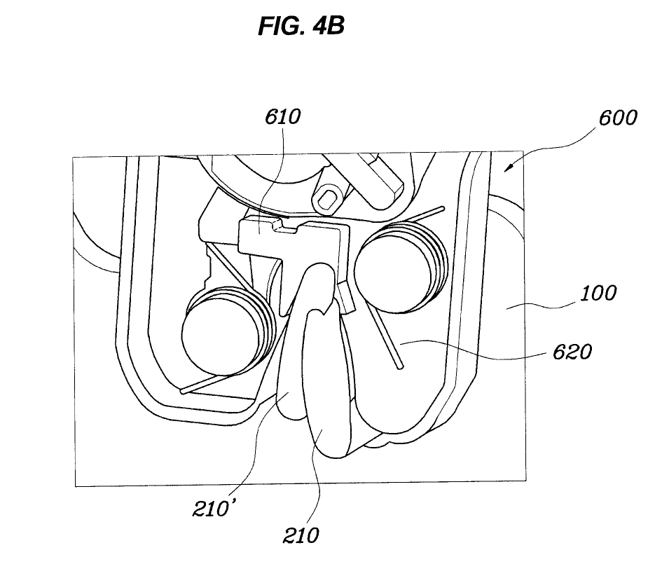

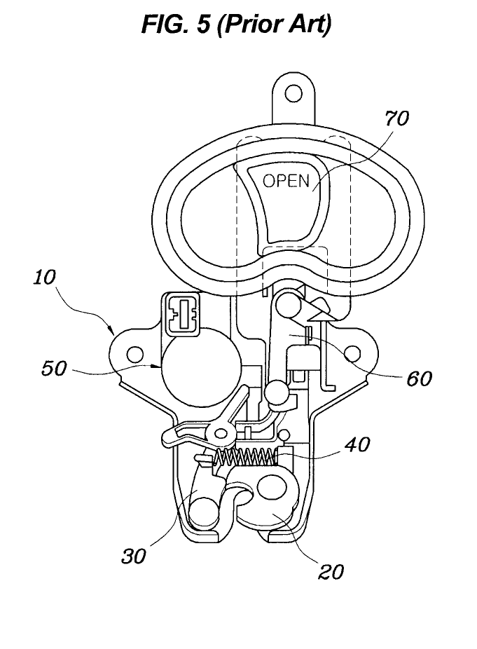

As shown in FIGS. 4A and 4B, to open the trunk lid, the striker 210 moves from a position, at which the trunk lid is locked, to a position, at which the trunk lid is unlocked, as shown with 210′ and pushes a trigger of the latch assembly 600 of the trunk lid upwards. Then, a latch 620 which has been in the locked state is released, and the trunk lid is opened.

When the trunk lid is closed, the striker 210 moves to the locking position, and the striker 210 pushes in a counterclockwise direction the latch 620 which has been in the open state. Then, the latch 620 is returned to the locked state, thus locking the trunk lid.

As described above, a striker assembly according to various embodiments of the present invention converts one-way rotational motion of a drive motor into reciprocating motion of a striker base using a relatively simple structure, thus easily changing a position of a striker for opening or closing a trunk lid.

Furthermore, the operation of the striker base is conducted by a controller which has a simple circuit structure, so that the production cost is reduced, and malfunction attributable to an electrical error is prevented, thus enhancing the reliability of the product.

For convenience in explanation and accurate definition in the appended claims, the terms “rear” and “upwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. A striker assembly to be locked to or unlocked from a latch assembly of a trunk lid for a vehicle, comprising:
a housing mounted to a vehicle body;
a striker base, one end of which is rotatably coupled to the housing, wherein the striker base includes a striker corresponding to the latch assembly;
an actuator mounted to a stationary member;
a power transmission unit to convert an actuating force of the actuator into a reciprocating motion of the striker base with respect to the one end of the striker base; and
a controller to apply an operating signal to the actuator.

2. The striker assembly as set forth in claim 1, wherein the stationary member is the housing.

3. The striker assembly as set forth in claim 1, wherein the actuator is a drive motor.

4. The striker assembly as set forth in claim 1, wherein the other end of the striker base is eccentrically coupled to the power transmission and configured to swing with respect to the one end of the striker base.

5. The striker assembly as set forth in claim 4, wherein a position limit member is configured to limit a reciprocating angle of the striker base.

6. The striker assembly as set forth in claim 5, wherein the position limit member is shaped of a slot formed through the striker base and a position limit protrusion is provided on the housing, the position limit protrusion slidably coupled to the slot so as to limit the reciprocating motion of the striker base within a predetermined range.

7. The striker assembly as set forth in claim 4, wherein the power transmission unit includes a rotating member that couples a rotation axis of the actuator and the other end of the striker base eccentrically.

8. The striker assembly as set forth in claim 7, wherein the power transmission unit further includes a direction conversion member that changes a movement direction of the other end of the striker according to a rotation angle of the rotating member.

9. The striker assembly as set forth in claim 8, wherein the direction conversion member includes a guide slot formed on the other end of the striker base and coupled to a guide protrusion formed on a distal end portion of the rotating member.

10. The striker assembly as set forth in claim 9, wherein the guide slot is curved into a ‘V’ shape and has an upper cam portion and a lower cam portion.

11. The striker assembly as set forth in claim 4, wherein the power transmission unit has:
a worm gear including a rotating shaft, the worm gear receiving an actuating force from the actuator through the rotating shaft;
a spur gear rotatably provided on the housing and engaging with the worm gear; and
a guide protrusion provided on the spur gear and being eccentrically coupled to a guide slot formed on the other end of the striker base.

12. The striker assembly as set forth in claim 11, wherein the striker base is configured to reciprocate between a locked position of the trunk lid and an unlocked position thereof when the rotating shaft rotates.

13. The striker assembly as set forth in claim 11, wherein the controller has a switch to supply a current having a same polarity such that the actuator is rotated in one direction, and the rotating shaft is rotated in the one direction when an operating signal of the controller is applied to the actuator.

14 The striker assembly as set forth in claim 11, wherein the guide slot comprises a cam structure curved into a ‘V’ shape.

15. The striker assembly as set forth in claim 11, wherein a position limit slot is formed through the striker base to limit the reciprocating motion of the striker base within a predetermined range, and a limit protrusion is provided on the housing and slidably coupled to the position limit slot.

16. A passenger vehicle comprising the striker assembly as set forth in claim 1.
